(19) United States
(12) Patent Application Publication
(10) Pub. No.: US 2018/0249548 A1
(43) Pub. Date: Aug. 30, 2018

(54) SMART ILLUMINATING SARTORIALS AND HANDBAGS

(71) Applicants: Michael M Saigh, Clayton, MO (US); Xiaohong Zhang, Clayton, MO (US)

(72) Inventors: Michael M Saigh, Clayton, MO (US); Xiaohong Zhang, Clayton, MO (US)

(21) Appl. No.: 15/444,729

(22) Filed: Feb. 28, 2017

(51) Int. Cl. H05B 33/08; G06F 3/16; A45C 15/06; A41D 27/08

(52) U.S. Cl. CPC H05B 33/0863; H05B 33/0845; A41D 27/085; A45C 15/06; G06F 3/165

(57) ABSTRACT

In described embodiments, includes a smartphone device and wireless or wireland application and one or more connectors. The software application enables various LED and lighting technologies to change colors to match or coordinate handbags with various apparel and sartorials. The present invention enables a purse's embedded or attached LED modules powered by a power source device and essential polarity connectors to ingrate smart phone software applications to adjust color coordination, patterns, designs and other control mechanisms i.e., (on/off), brightness, and other features.

### CROSS-REFERENCE TO RELATED APPLICATIONS

This application is a provisional application titled ILLUMINATING HANDBAGS AND SATORIALS and filed with the USPTO on the date of Feb. 28, 2017 at the teachings of which are incorporated herein in their entireties by reference.

### STATEMENT REGARDING FEDERALLY SPONSORED RESEARCH OR DEVELOPMENT:

Not applicable.

Field of the Invention: The present invention and disclosure relates generally to smart applications customized lightening and illumination technologies for sartorial and handbags to coordinate and adjust illumination, color, intensity and other features.

### BACKGROUND

### Description of the Related Art

Currently Apparel

The definition of a sartorial is an article of clothing, body wearable, purse or an object held. In addition, a sartorial can be constructive of any material, more than one compounds, composites and integrated to synthetic, man-made devices or natural molecules.

RGB are defined as light beams (one red, one green and one blue) must be superimposed (for example by emission from a black screen or by reflection from a white screen). Each of the three beams is called a component of that color, and each of them can have an arbitrary intensity, from fully off to fully on, in the mixture. In addition, the RGB color model is additive in the sense that the three light beams are added together, and their light spectra add, wavelength for wavelength, to make the final color's spectrum. This is essentially opposite to the subtractive color model that applies to paints, inks, dyes, and other substances whose color depends on reflecting the light under which we see them.

Encase or encasement is defined as a clos fitting surround made of any material or compound.

Slit is defined as one or more opening, narrow cut, elongated cut, round cut or multiple opening.

Presently illuminating shoes for example are static in nature and not designed for sartorial fashion. In addition, presently illumination found on clothing are static and are not dynamically designed for alteration as needed for fashion and design.

### SUMMARY

The present invention enables handbags and sartorials to change colors, designs, insignias, symbols, emblems, initials, logo, patterns, contours to match and integrate through smart illumination.

One embodiment of the present invention includes a mobile application for one or more mobile platforms. The application enables users to turn the LED embedded or attached to the purse or other sartorial lighting and illumination capabilities.

The smartphone will then be wired through a connection embedded within the purse or sartorial to the smartphone and connected to a USB port or other connections.

In another embodiment, the prewired and embedded LED lights within the lining of the purse. The LED lighting strip, more than one strip, various LED lightening configurations, one or more inserted LED fittings, one or more inserted LED patterns, etc. can be inserted through one or more interlinings within the purse.

In another embodiment of the present invention there are various slits or opening large enough to fit the LED tube and including the water resistant tubing. The tubing is the encasement material including but not limited to rubber, plastic, synthetic rubber, polybetaine or other material such as an insulated material if needed which can protrude through the purse exterior and the interlining of the purse. This interlining can be one or more linier strands of LEDs, curve strands of LEDs, single LED, patterned LEDs or a combination of any number of LEDs optimal for display purposes for purse and sartorial designers and manufacturers.

The control application software applied to sartorials and purse illumination lightening technologies is referred to as Smart Illumination Sartorials (SIS). Furthermore, SIS is connected to various mobile platforms. The SIS database can enable users to choose from basic illumination colors or customized illumination colors.

In addition, the SIS software can set up and configure the LED display through a wireless connection embedded in the purse/sartorial or provided as an independent module for the application.

The features can include but not limited to the adjust brightness from low (dim) to high (bright) and display adjustments which can help optimize for example daylight as opposed to nighttime or indoor or other environmental contrasts.

In another embodiment SIS can adjust color using a customized color chart to match the purse with the person's apparel or contrast the purse with the person's apparel.

In another embodiment SIS enables the user choose patterns from an array of patterns customize patterns and colors through a camera to snapshot (photo). In other words, the phones camera can take a picture of one or more apparels such as show color or pattern, shirt color or pattern, skirt color or pattern or any garment or object. The SIS program could then match the corresponding appearance as desired by the user.

In addition, another embodiment can more than one snapshot color, pattern or image could be displayed one or multiple sides of the purse or sartorial. In addition, a symbol, screen saver image, wallpaper image, downloadable image such as for example; photograph of scenery, logo, trademark, etc.

In addition in another embodiment of the present invention, the LED displays can be powered by a battery based on the required Amps and Watts depending on the LED's length and power requirements. LED in similar fashion to the display brightness uses more power than when the setting is dimmer and thus requires more power. The other factor includes the total length of the collective LED strips or collective number of LEDs. For example, if the collective LED on a purse totals 2 feet at present the power requirement will approximate 4.8 watts per meter. Watts is the product of volts' times amps. 4.8 W and 12V. Amps=4.8/12=0.4 A or 400 milliamperes. Thus the 2′ strip will use less than four tenths of an ampere. Presently, if Alkaline AA batteries are used they are currently rated at 2.12 Amp hours of energy, thus, the purse display should last 2.12/0.4=5.3 h over five hours.

The polarity can be built into the connectors from the battery or power pack to the LEDs and can be switched on and off through either the SIS or a switch conveniently located on the handbag or sartorial.

In addition, the LED display could interface a computer or smart device, controllers, search capabilities, Internet and wireless capabilities, typing or auditory voice recognition capabilities in order to conveniently increase viewable display areas for all handbags (backpacks, purses, pocketbooks, shoulder bags and other wearable or worn sartorials. The LEDs can vary in density and pixel count to include a variety of functions from low resolution to high resolution. The outer handbag can also be configured for other display technologies besides LED illumination and include a variety of screen technologies, including touch screen capabilities.

In another embodiment of the present invention the SIS system enables users the ability mix and match patterns, rotate patterns, create movement, change colors and patterns through a timer etc.

In additional another embodiment of the present invention the SIS system could store and retrieve favorite colors and patterns etc. to use when needed.

In another embodiment can enable clothing manufacturers with the ability to code the colors and patterns in the label in order for the SIS to exactly match the apparel item with the LED display. This code could be entered or the camera could snapshot the code for the SIS to recognize the computer barcode or a sequence of identifiers.

In addition, the SIS and combined fashion statement and LED series, descriptions and display images can be shared and used by others wearing the same or similar garments for example.

This dynamic for of illumination technology for the textile industry can in other embodiments enable other smart applications such as personal and parcel safety, GPS locators, video and audio encapsulation, in addition to the fashionable statement made by the present invention and as described wherein.

In addition in another embodiment of the present invention, SIS can incorporate artificial intelligence and smart biometrics measurements enhancements. For example, the handle of the purse when held can embed sensors to measure various biometrics such as but not limited to SPO2, Temperature, Pulse, Blood Pressure, Glucose and other biometrics. The SIS system can read such biometrics from a purse handle or other clothing units equipped with sensors.

In addition, the purse can utilize the SIS and illumination system for any shape, size and design of a purse or sartorial, In addition, any material can be used for the outer purse and the interlining. Pockets in the purse and other special designs can help increase its functionality and features.

In addition, PCB microprocessors, memory, software and firmware, transistors, switches, battery, wires, wireless technologies and other equipment can be added or embedded in a purse or other clothing in order to provide similar (SIS) functionality independent of the smartphone when required for some markets.

Furthermore, in a new or previously owned and retrofitted purse or clothing item design can be equipped and design with smart illumination and the SIS system

### BRIEF DESCRIPTION

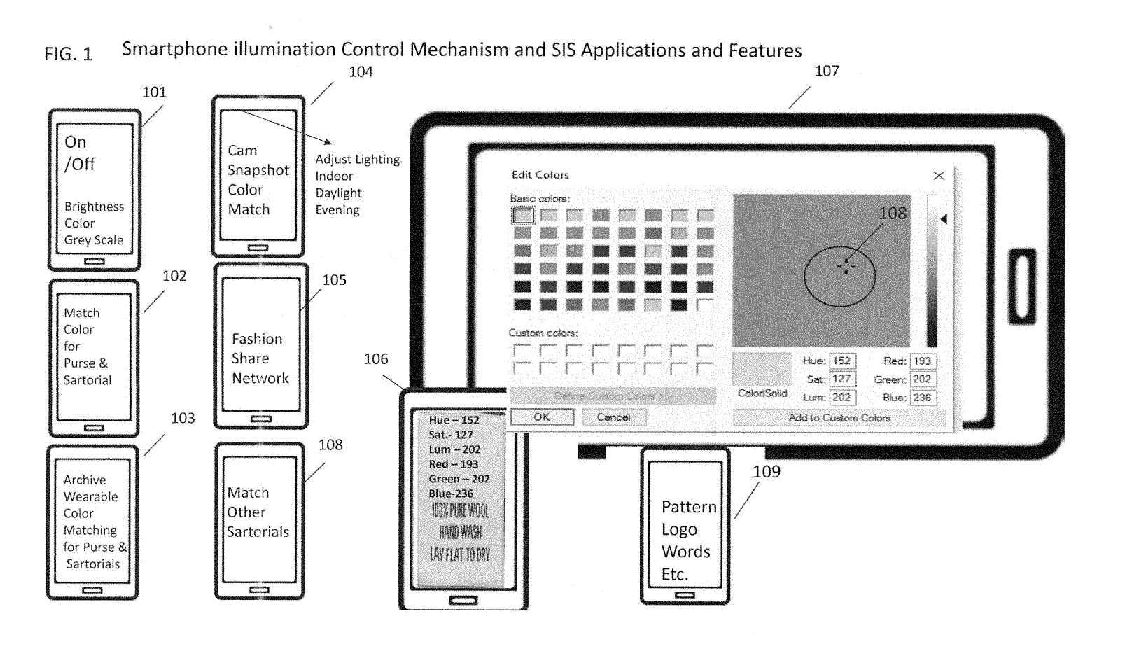

FIG. 1 shows a representation exemplified of a block diagram of the Smartphone Control System Mechanism and SIS software applications and Features in accordance with the embodiments of the present invention.

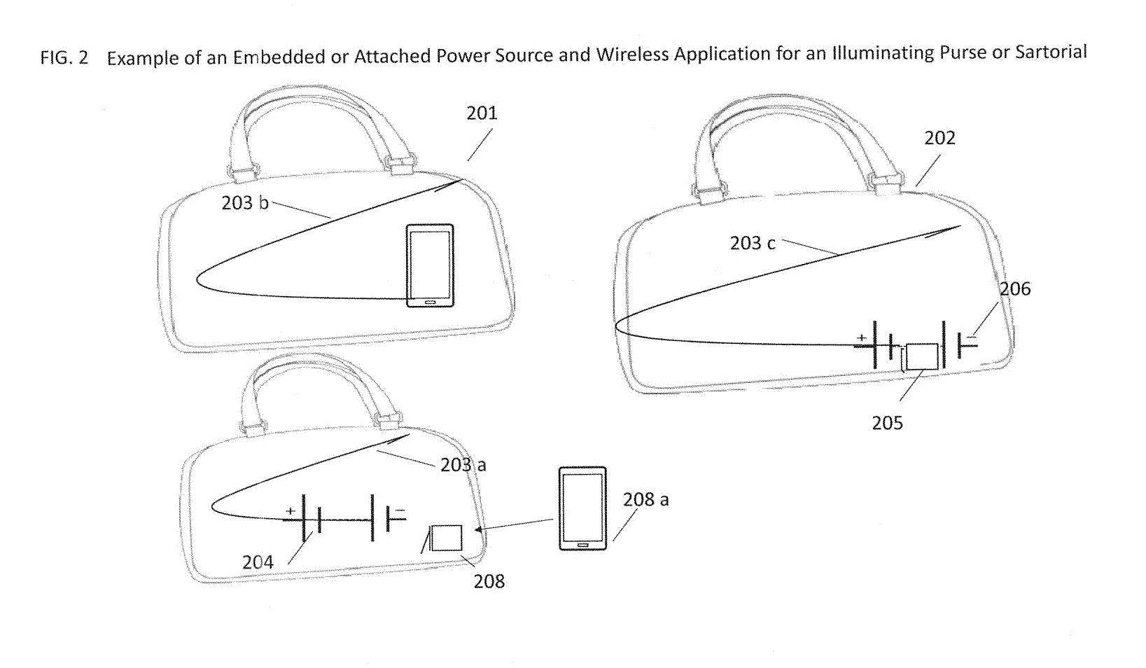

FIG. 2 exemplifies an Embedded Power Source for an Illuminating Purse or Sartorial in accordance with the embodiments of the present invention.

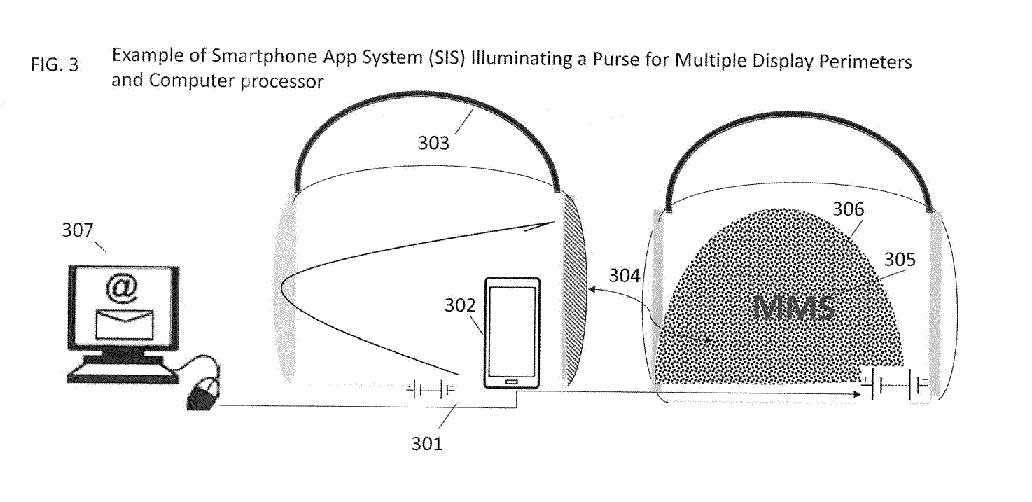

FIG. 3 shows an example of a Smartphone App System (SIS) for a purse for Multiple Display Parameters in the accordance with the embodiments of the present invention.

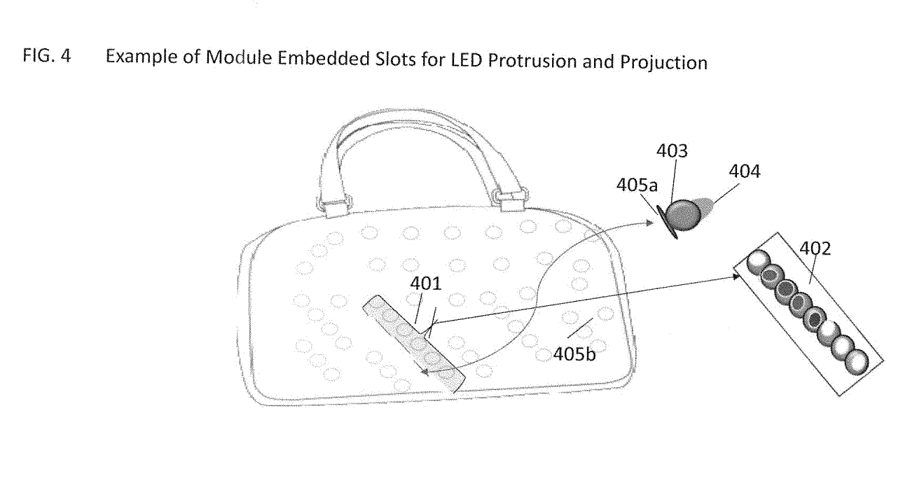

FIG. 4 shows and example of one or more LED interlining modules and slots for LED Protrusion and Projection in accordance with the embodiments of the present invention.

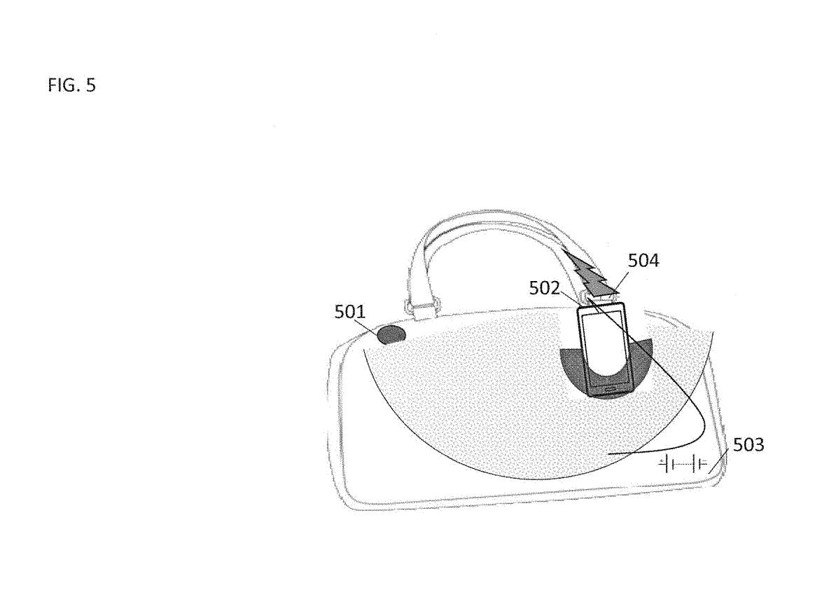

FIG. 5 is an example of in accordance with the embodiments of the present invention.

### DETAILED DESCRIPTION

FIG. 1 represents and exemplifies various software applications and embodiments of the present invention designed to enable a purse and other sartorials to illuminate through smartphones and various cellular and wireless platforms. The SIS system control mechanisms include but not limited to one or more functions and features as it relates to the illumination of embedded or attached LED to the garment or purse. 101 exemplifies the initial on/off switch which starts and turns (on or off) the LED or a series of LEDs. The SIS software system enables app users to choose or customize and editing tools 107 in order to choose the RBG color spectrum for the LED components. 106 exemplifies a clothing label color code and manually enter the color code (Hue, Sat., Lum., Red, Green Blue, etc.) or snapshotted by the phone's camera in order to exactly match through the labels bar code. in accordance with the embodiments of the present invention. 107 includes the editorial choice of various combination of light frequencies or the customization of color combinations code (Hue, Sat., Lum., Red, Green Blue, etc.) In addition, the SIS system can adjust the LED brightness for any environmental condition and changes in ambient light as exemplified by 101. In addition, either 101 color LED illumination or grey scale can be controlled and matched 102 along with other SIS control features and functions. Archival retrieval as represented by 103 exemplify an history of favorite colors which match one or more sartorials, handbags, garments (shirts, pants, blouses, swim suits), pieces of apparel, coats, shoe, etc. 105 examples SIS technology which can network color matching and SIS fashion illumination technology through various social networks such as Facebook etc. 108 exemplifies the exact matching customized color or pattern 109 and its corresponding color chart components and previously described. Furthermore, patterns, logos, emblems, advertising logos, pictures, animation etc. can be programmed to be displayed and controlled by SIS on one or more LED parameters. 108 exemplifies the matching of other smart clothing and LED (SIS) devices with the purse and other textile accessories.

FIG. 2 represents an Embedded or Attached Power Source and Wireless Application for an Illuminating Purse or Sartorial as it relates to the SIS system. 205 represents an independent PCB, microprocessors, memory storage, battery, transistors and other computerized components and chip which can independently operate the SIS system independently if desirable to some apparel designs and owners of apparels including and not limited to all textile garments, sartorial wearable devices and handheld SKUs which are illuminated. 202 represents an example of an independent computer module connected or embedded intricately or superficially to a purse or other apparel items. In addition, 204 represents an example of the positive and negative charges (polarity) from battery through connectors 203a, 203b, 203c embedded in a purse and providing the necessary current; (AMPs, Watts, Volts) required for illumination, various features and controls through a SIS type of software application. 208 exemplifies Bluetooth or wireless means of controlling the illumination through the SIS systems app when the phone is removed from the purse when in use for other purposes, i.e., phone calls, texting, using other apps etc. 201 exemplifies yet another smartphone application where the mobile device is utilized directly and connected directly to the LED source when applicable.

FIG. 3. 303 is the handle of a purse where the handle is for grabbing the apparel or could be embedded with various biosensors to measure one or more biometrics such as but not limited to SPo2, pulse, temperature, lactic acid, glucose monitoring through sweat, blood pressure, through wrist strap and other biometrics. 305 shows various patterns, colors, textures, designs, logos, emblems, initials (306, 304, 305) which as previously described in FIG. 1. LED illumination can be customized, standardized or accessed from one or more databases and through one or more features and SIS system functions. One embodiment of the present invention includes but is not limited to a plurality of designs being used concurrently, symmetrically or asymmetrically in order to display when needed multiple visual perimeters. In addition, in yet another embodiment of the present invention animation, video, audio and interactive multimedia can be utilized. Furthermore, the display can be utilized as a computer display monitor with internet services, wireless communication to perform similar functions as a computer processor represented by 307 operation including but not limited to the combination of microprocessors, mouse or auditory controllers. In addition, the smartphone 302 can connect to a purse screen LED and light source display in order to provide a larger portable screen size display. 301 exemplifies either wireland or wireless connections which interconnect a plurality of LED units. In addition, if the purse or other sartorial device display monitor or apparel garment display if pixelized as densely as required for clear viewing, pictures and the written word. In addition, the purse display could be a touch screen for some computer applications and functions.

FIG. 4 shows a mesh, configuration pattern of LED lights as represented by 401. Furthermore, the LED patter and configuration could consist of widespread LED illumination to densely pixeled displays for computer functionality as described in FIG. 3. In addition, the pattern of various LED displays configurations can be adjusted to the functionality and usage. 402 represents an example of a LED strip or multiple LED strip with the ability to colorize. 405b represents a more random LED approach required for some purse or garment designs. 405a shows a slit or opening where the LED lights are protected by a one or more sealants, materials or components 403 in order to be water proof or water resistant. 404 represents one or more LED lights powered by a battery and controlled by the smart device or an independent computer device.

FIG. 5 represents an example of one or more surface switches and controllers for example 502 is the on and off switch in one embodiment. The outer layer controller apparatus is for the convenience of the user and design for women/men when it's not convenient to open their wallet or purse. It is understood that smart wallets for men could embed similar functionality as describe by the present invention. In addition, 502 represents a combination of the convergence of a smart mobile device attached to various biosensors for measurement hand biometric measurements as show exemplary by 504. The smart mobile device shown as a component of the handbag, wallet or garment 503 can securely fascine to the handbag for convent reading of various measurements. In addition, 504 represents an example of alerting vibration patterns, audio or visual signals for biometrics, environmental, theft and computer applications.

It should be understood that the steps of the exemplary methods set forth herein are not necessarily required to be performed in the order described, and the order of the steps of such methods should be understood to be merely exemplary. Likewise, additional steps may be included in such methods, and certain steps may be omitted or combined, in methods consistent with various embodiments of the present invention.

As used herein in reference to an element and a standard, the term “compatible” means that the element communicates with other elements in a manner wholly or partially specified by the standard, and would be recognized by other elements as sufficiently capable of communicating with the other elements in the manner specified by the standard. The compatible element does not need to operate internally in a manner specified by the standard.

Also for purposes of this description, the terms “couple,” “coupling,” “coupled,” “connect,” “connecting,” or “connected” refer to any manner known in the art or later developed in which energy is allowed to be transferred between two or more elements, and the interposition of one or more additional elements is contemplated, although not required. Conversely, the terms “directly coupled,” “directly connected,” etc., imply the absence of such additional elements. Signals and corresponding nodes or ports may be referred to by the same name and are interchangeable for purposes here.

It will be further understood that various changes in the details, materials, and arrangements of the parts which have been described and illustrated in order to explain the nature of this invention may be made by those skilled in the art without departing from the scope of the invention as expressed in the claims to be filed upon the USPTO utility and International filing.

We claim:

1. A system comprising of component which controls software applications for a smart handbag device.

2. The system of claim 1 wherein smart handbag can include different color of lighting.

3. The system of claim 1 wherein said the software application can control lighting on and off.

4. The system of claim 3 wherein said the software application can control lighting with different color combination

5. The system of claim 4 wherein said the software application can control lighting with different sequences and patterns

6. The system of claim 1 wherein smart handbag include playing music ability

7. The system of claim 6 wherein said music can be powered by blue-tooth or a smart device.

8. A system and computer apparatus comprising network connection with smart handbag.

9. The system of claim 8 wherein said software application can control lightings on the handbags as decoration of handbag

10. The system of claim 8 wherein said the lighting can be customized by each person

11. The system of claim 8 wherein said the lighting can be customized through software application

12. The system of claim 8 wherein said the lightings have selection consistent color, brightness and on-and-off.

13. The system of claim 8 wherein said the software application can program lighting various with color, brightness and on-and-off.

14. The system of claim 8 wherein said the music can be customized by each person

15. The system of claim 8 wherein said the music can be customized through software application

16. The system of claim 8 wherein said the network connection can be wireless or wired connection.
